(19) United States
(12) Patent Application Publication
(10) Pub. No.: US 2017/0210494 A1
(43) Pub. Date: Jul. 27, 2017

(54) UNPRESSURIZED CARGO TRANSFER PALLET AND STRUCTURAL SUPPORT

(71) Applicant: The Boeing Company, Chicago, IL (US)

(72) Inventor: Christopher B. BLACKWELL, League City, TX (US)

(21) Appl. No.: 15/002,435

(22) Filed: Jan. 21, 2016

(51) Int. Cl. B64G 1/64; B64G 1/58; B64G 1/56; B64G 1/42; B64G 1/54

(52) U.S. Cl. CPC B64G 1/641; B64G 1/42; B64G 1/54; B64G 1/56; B64G 1/58; B64G 1/645

(57) ABSTRACT

An unpressurized cargo pallet including a pallet base having a frame, the frame being conformal with a structural exterior surface of a space vehicle to effect structural integration of the pallet base with the structural exterior surface of the space vehicle so that the pallet base forms a portion of the structural exterior surface, where the frame includes an interior surface, and an exterior surface that forms at least part of the structural exterior surface of the space vehicle, a cargo attachment interface disposed on the interior surface of the frame, and at least one grapple disposed on the exterior surface of the frame.

### BACKGROUND

Orbiting platforms require regular delivery of cargo from Earth. Transportation from Earth to the orbiting platforms exposes the cargo to hazards, including extreme temperatures, high external forces, micro meteoroid and orbital debris (MMOD) strikes, and more. Traditionally, protecting the cargo from the hazards has been resolved by storing the cargo in a standalone transfer vehicle or in the payload bay of a manned vehicle. Examples of standalone transfer vehicles and manned vehicles include the space shuttle, SpaceX's Dragon capsule, and Japan's H-II transfer vehicle. These vehicles generally use large panels along the outer mold line of the vehicle to protect the cargo, located within the vehicle, during ascent but, which must be moved or removed in order to access the cargo once in orbit. After removal, a robotic manipulator, for example a space station robotic manipulator, must be moved or extended inside the vehicle to extract the cargo, which is typically mounted on a separate transfer pallet within the vehicle. However, the required robotic operation of the robotic manipulator within an enclosed space, such as the interior of a space vehicle, to extract the cargo may damage the cargo, vehicle, robotic manipulator, or orbiting platform.

Previously, others have tried to solve this problem by designing a mechanized transfer system within the transport vehicle. Once rendezvoused with the orbiting platform, an outer mold line panel is removed via an internal mechanism or the robotic manipulator, and the cargo is thrust outside of the vehicle outer mold line, as described in U.S. Pat. No. 7,198,233. This design however, involves several complex mechanisms which, if fail, can result in mission loss. Additionally, variations of this design apply significant off axis forces to the docking/birthing adapters of the orbiting platform, which could result in damage to the orbiting platform.

Thus, it would be advantageous to be able supply a system that reduces the total number of mechanisms and structural supports required for unpressurized cargo resupply and be able to remove the cargo without having to enter the vehicle.

### SUMMARY

Accordingly, a system and method, intended to address the above-identified concerns, would find utility.

One example of the present disclosure relates to an unpressurized cargo pallet including a pallet base having a frame, the frame being conformal with a structural exterior surface of a space vehicle to effect structural integration of the pallet base with the exterior surface of the space vehicle so that the pallet base forms a portion of the structural exterior surface, where the frame includes an interior surface, and an exterior surface that forms at least part of the structural exterior surface of the space vehicle, a cargo attachment interface disposed on the interior surface of the frame, and at least one grapple disposed on the exterior surface of the frame.

One example of the present disclosure relates to a space vehicle including a frame having a structural exterior surface and forming an interior cavity, and at least one unpressurized cargo pallet, each unpressurized cargo pallet including a pallet base being conformal with the structural exterior surface of the frame of the space vehicle to effect structural integration of the pallet base with the structural exterior surface of the frame of the space vehicle so that the pallet base forms a portion of the structural exterior surface, where the pallet base includes an interior surface, and an exterior surface that forms at least part of the structural exterior surface of the frame of the space vehicle, a cargo attachment interface disposed on the interior surface of the pallet base, and at least one grapple disposed on the exterior surface of the pallet base.

One example of the present disclosure relates to a method of transferring unpressurized cargo, the method including interfacing with a grapple disposed on an exterior surface of an unpressurized cargo pallet, exterior to a space vehicle to effect movement of the unpressurized cargo pallet relative to a frame of the space vehicle, where the unpressurized cargo pallet forms a portion of a structural exterior surface of the space vehicle and cargo carried by the unpressurized cargo pallet is disposed within an interior cavity of the space vehicle, decoupling the unpressurized cargo pallet from the frame of the space vehicle, and separating, through the interface with the grapple, the structural exterior surface of the space vehicle formed by the unpressurized cargo pallet from the frame of the space vehicle to remove the cargo carried by the unpressurized cargo pallet from the interior cavity.

### BRIEF DESCRIPTION OF THE DRAWINGS

Having thus described examples of the disclosure in general terms, reference will now be made to the accompanying drawings, which are not necessarily drawn to scale, and wherein like reference characters designate the same or similar parts throughout the several views, and wherein:

FIG. 1 is a block diagram of a unpressurized cargo transfer pallet system according to one or more aspects of the present disclosure;

FIG. 2 is a schematic illustration of the unpressurized cargo transfer pallet system according to one or more aspects of the present disclosure;

FIG. 3 is a schematic illustration of the unpressurized cargo transfer pallet system according to one or more aspects of the present disclosure;

FIG. 4 is a schematic illustration of the unpressurized cargo transfer pallet system according to one or more aspects of the present disclosure;

FIGS. 5 and 5a are schematic illustrations of the unpressurized cargo transfer pallet system as it interfaces with the frame of the space vehicle according to one or more aspects of the present disclosure;

FIG. 6 is a schematic illustration of the unpressurized cargo transfer pallet system as it interfaces with the frame of the space vehicle according to one or more aspects of the present disclosure;

FIG. 7 is a schematic illustration of the unpressurized cargo transfer pallet system as it interfaces with the frame of the space vehicle according to one or more aspects of the present disclosure;

FIG. 8 is a flow diagram for transferring cargo according to one or more aspects of the present disclosure;

FIG. 9 is a flow diagram of spacecraft production and service methodology according to one aspect of the present disclosure; and

FIG. 10 is a schematic illustration of the space vehicle including distributed vehicle systems according to one aspect of the present disclosure.

In the block diagram(s) referred to above, solid lines, if any, connecting various elements and/or components may represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. Couplings other than those depicted in the block diagrams may also exist. Dashed lines, if any, connecting the various elements and/or components represent couplings similar in function and purpose to those represented by solid lines; however, couplings represented by the dashed lines may either be selectively provided or may relate to alternative or optional aspects of the disclosure. Likewise, elements and/or components, if any, represented with dashed lines, indicate alternative or optional aspects of the disclosure. Environmental elements, if any, are represented with dotted lines.

In the block diagram(s) referred to above, the blocks may also represent operations and/or portions thereof. Lines connecting the various blocks do not imply any particular order or dependency of the operations or portions thereof.

### DETAILED DESCRIPTION

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Reference herein to “one example” or “one aspect” means that one or more feature, structure, or characteristic described in connection with the example or aspect is included in at least one implementation. The phrase “one example” or “one aspect” in various places in the specification may or may not be referring to the same example or aspect.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

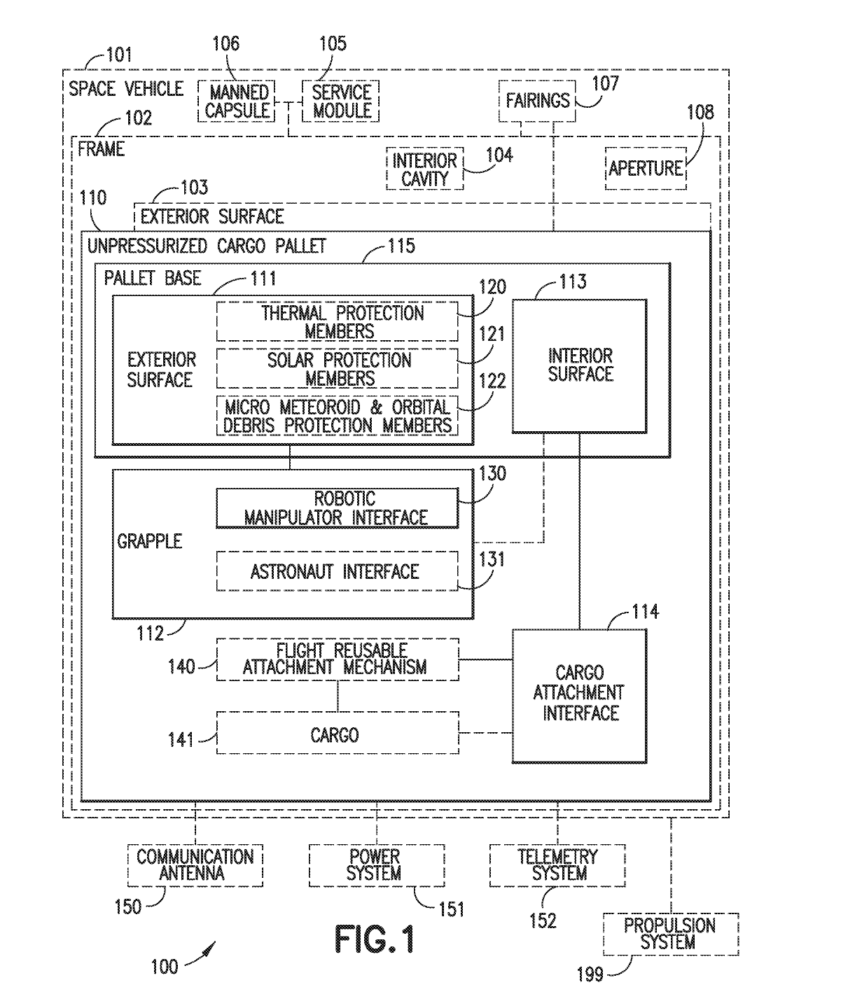

Referring now to FIG. 1, the aspects of the present disclosure described herein provide for an unpressurized cargo transfer system 100 having a grapple point 112 external to a space vehicle's outer mold line or structural exterior surface 103. The unpressurized cargo transfer system 100 is configured so that a robotic manipulator or other manipulator, such as, e.g., a space station robotic manipulator, attaches to at least a portion of the unpressurized cargo transfer system 100 and manipulates cargo 141 held by the unpressurized cargo transfer system 100 without having to enter inside the space vehicle 101 past the space vehicle's structural exterior surface 103 and avoiding contact with the space vehicle 101 that may adversely affect the robotic manipulator or the space vehicle 101. Additionally, the unpressurized cargo transfer system 100 reduces the total amount of hardware and number of mechanisms required to deliver the cargo 141 to an orbiting platform, thus reducing mass, energy required to operate mechanisms, and energy required to achieve orbit.

The unpressurized cargo transfer system 100 includes at least one structural unpressurized cargo pallet 110, having a pallet base 115, a cargo attachment interface 114 and at least one grapple 112. The unpressurized cargo transfer system 100 protects the cargo 141 during delivery to an orbiting platform, while providing unobstructed access for a robotic manipulator or astronaut to remove the cargo 141. In order to protect and provide unobstructed access, the at least one unpressurized cargo pallet 110 is configured to be at least partially inserted into aperture 108 of the space vehicle 101 and form at least part of the structural exterior surface 103 so as to be integrated or integral with an airframe (generally referred to as frame 102) of the space vehicle 101 (e.g. the at least one unpressurized cargo pallet 110 forms a part of the frame 102). The pallet base 115 includes an exterior surface 111 and an interior surface 113. The cargo attachment interface 114, such as a flight reusable attachment mechanism 140, is connected to or otherwise mounted on the interior surface 113 of the pallet base 115 and the at least one grapple 112 is connected or otherwise mounted on the exterior surface 111 of the pallet base 115. Integration of a flight reusable attachment mechanism 140 or any other cargo attachment interface 114 with the at least one unpressurized cargo pallet 110, provides a robotic manipulator and/or astronaut a way to remove the cargo 141 without making contact with or entering the space vehicle 101. In one aspect, the at least one grapple 112 provides an unobstructed access point for the robotic manipulator or the astronaut to remove the cargo 141. In one aspect, mounting the at least one grapple 112 on the exterior surface 111 of the pallet base 115, outside (e.g. exterior to) the space vehicle 101 provides for robotic operations to be performed in unobstructed areas entirely outside the space vehicle 101. Moving the robotic operations to an area that does not have obstructions reduces the possibility of making adverse contact with the space vehicle 101 and reduces the overall complexity of cargo transfer by reducing the total amount of hardware required for cargo transfer.

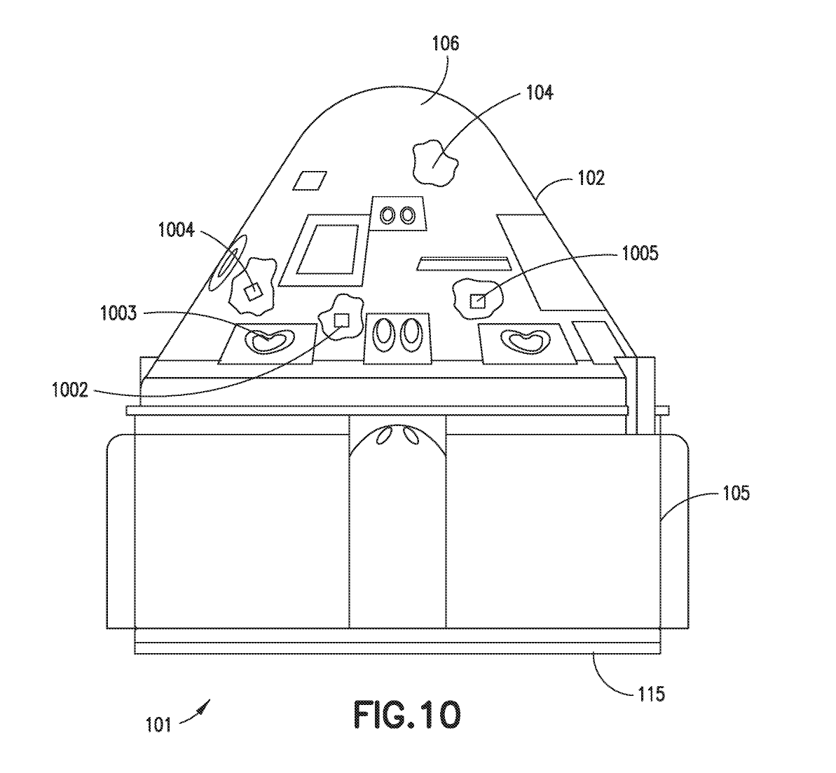

Still referring to FIG. 1, in one aspect, the unpressurized cargo transfer system 100 includes the at least one unpressurized cargo pallet 110, while in other aspects the unpressurized cargo transfer system 100 includes the at least one unpressurized cargo pallet 110 and a space vehicle 101 configured to transport the cargo 141 from at least a terrestrial origin to space. In other aspects, the space vehicle 101 may be configured to return cargo 141 to the terrestrial origin from space. In one aspect, the space vehicle 101 is part of a transport system for transporting items to and from space from a terrestrial origin. The space vehicle 101 may be a shuttle or stand-alone orbiting or non-orbiting platform, which may include one or more of a manned capsule 106 and an unmanned flight service module 105 (see FIG. 10). In one aspect, the unpressurized cargo transfer system 100 may also include a propulsion system 199 such as any suitable rocket (e.g. the Falcon 9, Atlas V, and Delta IV rockets), where the space vehicle 101 is carried by the rocket. For example, the space vehicle 101 is attached to the propulsion system 199 for carrying the space vehicle 101 into space. Upon reaching orbit and a desired extraction point, such as docking with an orbiting platform, the cargo 141 is extracted from the space vehicle 101 as will be described herein. In one aspect, the space vehicle 101 may be reusable, returning intact to the terrestrial origin, or the space vehicle 101 may be a single use expendable vehicle which perishes after successfully delivering the cargo 141 to the orbiting platform.

In one aspect of the present disclosure, the space vehicle 101 includes the frame 102, the structural exterior surface 103, an interior cavity 104, the aperture 108 formed through the structural exterior surface 103 and in communication with the interior cavity 104, and at least one unpressurized cargo pallet 110. In other aspects, the space vehicle 101 also includes one or more fairing 107. The structural exterior surface 103 forms an outer mold line of the space vehicle 101 which protects cargo 141 disposed on the at least one unpressurized cargo pallet 110 within the interior cavity 104 of the space vehicle 101. In order to protect the cargo 141 carried on the at least one unpressurized cargo pallet 110, the at least one unpressurized cargo pallet 110 forms a portion of the structural exterior surface 103 of the space vehicle 101 so as to form a portion of the frame 102.

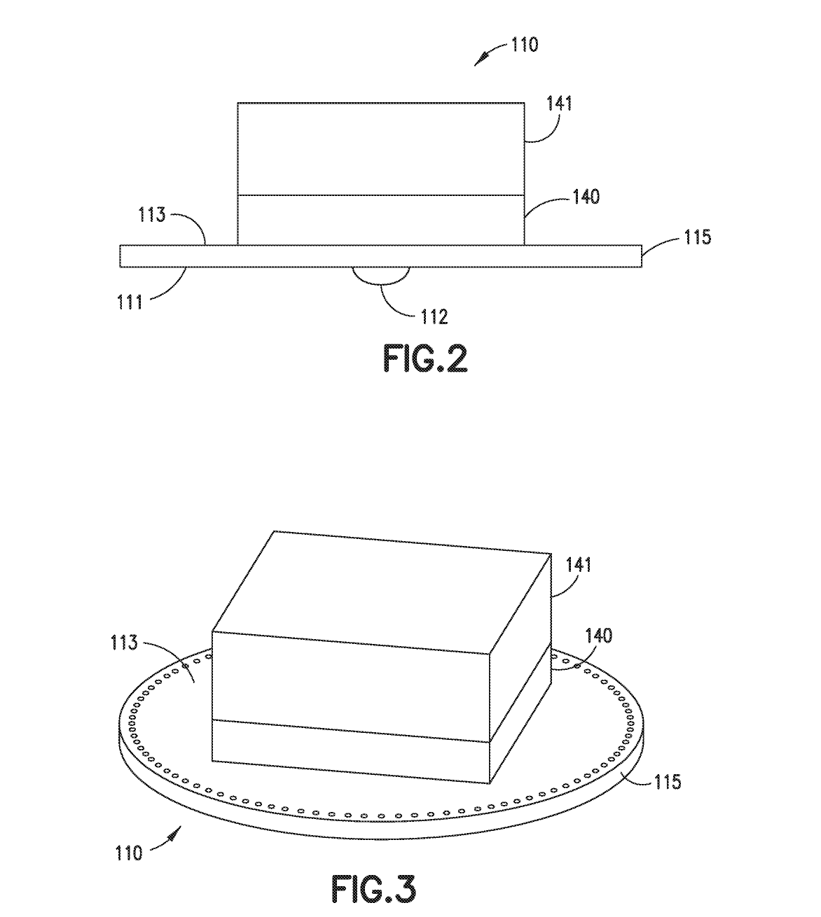

Referring also to FIGS. 2-4, an example of the at least one unpressurized cargo pallet 110 is shown. The at least one unpressurized cargo pallet 110 may have a substantially similar configuration to the frame 102 which forms the structural exterior surface 103 of the space vehicle 101. In one aspect, the at least one unpressurized cargo pallet 110 may be manufactured by casting, additive manufacturing, integral machining, composite layup, composite forming, or any other method. In one aspect, the at least one unpressurized cargo pallet 110 can be made from a single material or a composite material. The at least one unpressurized cargo pallet 110 may be pre-fabricated as one piece including the flight reusable attachment mechanism 140, the at least one grapple 112, and the pallet base 115 with exterior/interior 111, 113 or may be assembled on or off the space vehicle 101 from multiple pieces. The at least one unpressurized cargo pallet 110 may be fabricated in any shape, such as a shape that is conformal to the shape of the space vehicle 101, including flat, curved, or any other geometry. When complete, the at least one unpressurized cargo pallet 110 forms a protective boundary for the cargo 141 from hazards such as meteoroid strikes, high external forces, extreme temperatures and any other hazard. In one aspect, the at least one unpressurized cargo pallet 110 may be enhanced or configured to provide, on or within the exterior surface 111 and/or interior surface 113 of the pallet base 115, one or more thermal protection members 120, solar protection members 121, or micro meteoroid and orbital debris protection members 122.

In one aspect of the disclosed embodiment, as described above, the at least one unpressurized cargo pallet 110 includes the pallet base 115, the at least one grapple 112, and the cargo attachment interface 114. The pallet base 115, cargo attachment interface 114, and at least one grapple 112 may be manufactured separately and integrated/assembled to form the at least one unpressurized cargo pallet 110, or the at least one unpressurized cargo pallet 110 (and its components) may be manufactured as one unitary piece. The at least one unpressurized cargo pallet 110 can be fully assembled prior to installation on the space vehicle 101. Likewise, the at least one unpressurized cargo pallet 110 could be assembled after some components have been installed onto the space vehicle 101 or at any other point during space vehicle 101 assembly or flight preparation. In one aspect, for example, the cargo 141 may be coupled to the flight reusable attachment mechanism 140, which as a unit is integrated or otherwise coupled onto the interior surface 113 of the pallet base 115 through the cargo attachment interface 114. The pallet base 115, with the flight reusable attachment mechanism 140 and cargo 141 attached, is coupled onto the space vehicle 101 so that the cargo 141 is disposed within the interior cavity 104 and the pallet base 115 forms a portion of the structural exterior surface 103 of the vehicle 101. In one aspect, the exterior surface 111 of the pallet base 115 is similar, in composition, to the structural exterior surface 103 of the space vehicle 101. When the at least one unpressurized cargo pallet 110 is integrated., e.g., coupled or attached, to the space vehicle 101, the structural exterior surface 103 and frame 102 of the space vehicle 101 and the pallet base 115 and its exterior surface 111 form a structural part of the space vehicle 101 and create a substantially uniform outer mold line of the space vehicle 101.

In one aspect, the cargo attachment interface 114 is mounted to the interior surface 113 of the pallet base 115, where the cargo attachment interface 114 may include flight reusable attachment mechanism 140. In one aspect, the cargo attachment interface 114 and/or flight reusable attachment mechanism 140 are configured such that cargo 141 may be attached to one or more of the cargo attachment interface 114 and flight reusable attachment mechanism 140. The flight reusable attachment mechanism 140 may be made of a single piece or nay be multiple pieces. Additionally, the flight reusable attachment mechanism 140 may be made of a single material or alternatively be a composite material. The flight reusable attachment mechanism 140 may be custom manufactured for specific cargo 141 or commercial off the shelf hardware that interfaces with the cargo 141.

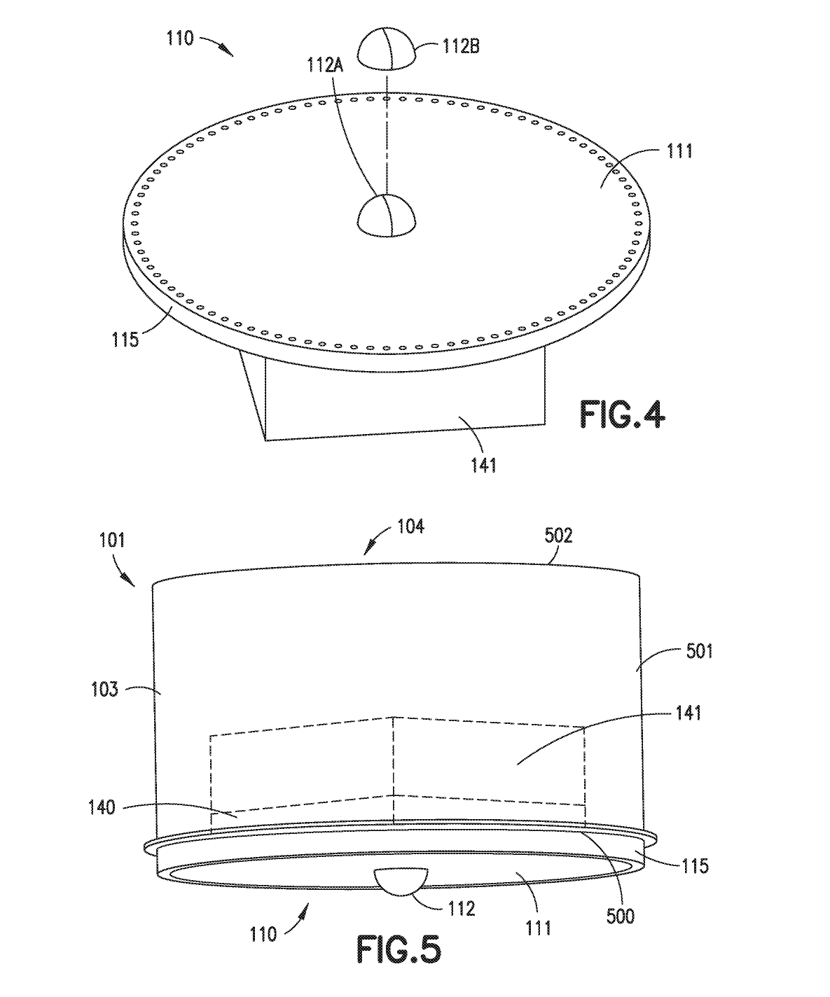

In one aspect, the at least one grapple 112 is mounted on the exterior surface 111 of the pallet base 115. In other aspects, at least one additional grapple 112 may be mounted on the interior surface 113 of the pallet base 115. The at least one grapple 112 may, in one aspect, include one or more of a robotic manipulator interface 130 and an astronaut interface 131. The at least one grapple 112 may be a single grapple or may be multiple grapples mounted on one or more of the exterior surface 111 and the interior surface 113 of the pallet base 115. The at least one grapple 112 may be fabricated with the pallet base 115 as a unitary one piece member or, in other aspects, the at least one grapple 112 may be attached to the pallet base 115 after the pallet base 115 is formed. In one aspect, the at least one grapple 112 may be releasably attached to the pallet base 115 for reconfiguration of the at least one grapple 112 before or after the space vehicle 101 ascends into orbit. In one aspect, the reconfiguration of the at least one grapple 112 includes removing a grapple 112A having a first configuration and replacing the grapple 112A with another grapple 112B having a different configuration where each configuration may be for engaging a respective one of differently configured robotic manipulators or for interfacing with an astronaut. (see FIG. 4)

Referring again to FIG. 1, the at least one unpressurized cargo pallet 110 may include one or more of a communication antenna 150, a power system 151, and a telemetry system 152. In one aspect, the communication antenna 150, for example, provides for communication between the cargo 141 attached to the at least one unpressurized cargo pallet 110 and/or a terrestrial or extraterrestrial base station such as a manned capsule 106, space station, satellite, etc. In one aspect, the power system 151, for example, provides power to the cargo 141 and/or the at least one unpressurized cargo pallet 110. In one aspect, the telemetry system 152 provides, for example, a status of the cargo 141 and/or the at least one unpressurized cargo pallet 110 to, e.g. the terrestrial and/or extraterrestrial base station. Each of the communication antenna 150, power system 151, and telemetry system 152 may be connected to the at least one unpressurized cargo pallet 110 and/or the space vehicle 101 through quick disconnect harnesses or umbilicals or any other connection.

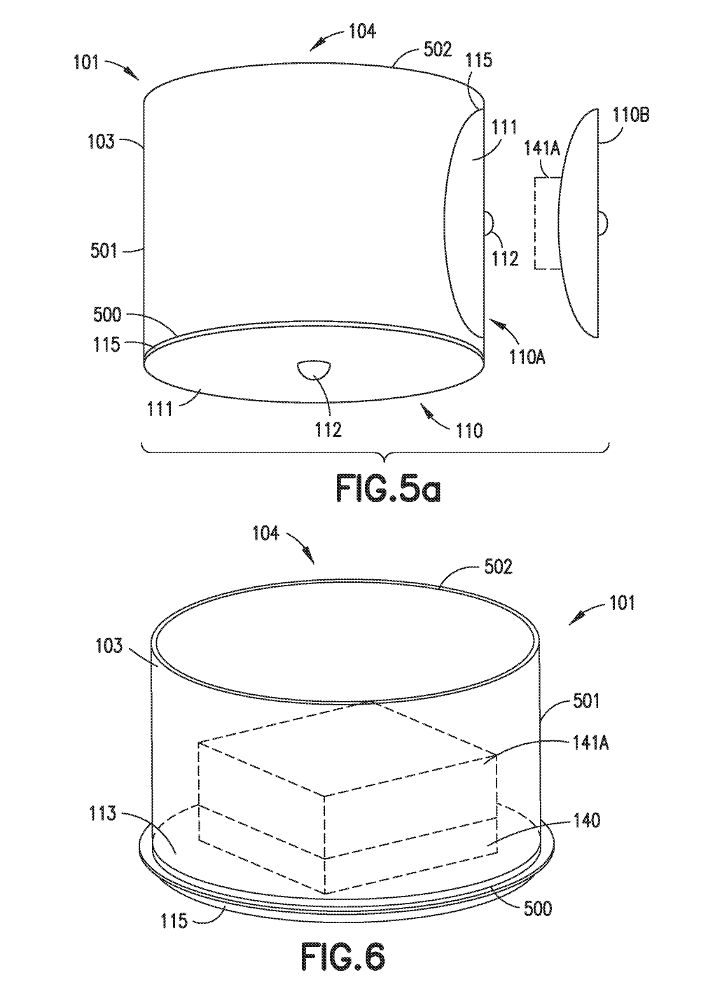

Referring now to FIGS. 5, 5a and 6, the at least one unpressurized cargo pallet 110 is shown coupled to space vehicle 101. In one aspect, the cargo 141 is disposed on the at least one unpressurized cargo pallet 110 and the at least one unpressurized cargo pallet 110 is coupled to a bottom 500 of the space vehicle 101. In other aspects, the at least one unpressurized cargo pallet 110 is coupled to a peripheral side 501 or top 502 of the space vehicle 101. While one unpressurized cargo pallet 110 is shown in FIGS. 5 and 6, in other aspects more than one unpressurized cargo pallet 110 may be coupled with the space vehicle 101 on one or more of the bottom 500, peripheral side 501, and top 502 (see FIG. 5a). The at least one unpressurized cargo pallet 110 may be coupled to space vehicle 101 using for example mechanized nuts or bolts, wire wound bolts, mechanized cleco-style pins, explosive bolts, explosive pins, or any other attachment hardware. As described herein, the unpressurized cargo transfer pallet system 100 has at least one grapple 112 on the exterior surface 111 of the at least one unpressurized cargo pallet 110 to provide the robotic manipulator or astronaut on the orbiting platform an unobstructed external access point (e.g. external to or outward of the space vehicle 101 outer mold line) to remove the at least one unpressurized cargo pallet 110 when the at least one unpressurized cargo pallet 110 is decoupled from the space vehicle 101. Once the at least one unpressurized cargo pallet 110 is removed from the space vehicle 101, via the robotic manipulator or the astronaut, the cargo 141 may be removed from the cargo attachment interface 114 and/or flight reusable attachment mechanism 140 without the need to enter the outer mold line formed by the structural exterior surface 103 of the space vehicle 101 to grasp the at least one unpressurized cargo pallet 110 and/or cargo 141. Removing the need to enter the vehicle reduces cost and hardware needed to transport the cargo 141 to the orbiting platform and reduces mass, energy to reach orbit, and/or energy to remove cargo 141 by substantially eliminating hardware configured to move the cargo 141 outside the space vehicle 101 or to a location within the space vehicle 101 where the cargo 141 can be grasped by, e.g., the robotic manipulator. In other aspects, the cargo 141 may remain attached to the pallet base 115 and the at least one unpressurized cargo pallet 110 may be affixed to the orbiting platform to provide storage or usage of the attached cargo 141.

In one aspect, the present disclosure provides for multiple unpressurized cargo pallets 110 which are interchangeable on the space vehicle 101. For example, a first unpressurized cargo pallet 110A may be attached to space vehicle 101 for delivering cargo 141 to the orbiting platform. Upon delivery, another unpressurized cargo pallet 110B may replace the first unpressurized cargo 110A on the space vehicle 101 for the return to, for example, the terrestrial origin. Additionally, the other unpressurized cargo pallet 110B may have other cargo 141A, such as equipment or experiment results, attached to the cargo attachment interface 114 and/or flight reusable attachment mechanism 140 for return to terrestrial origin, or in other aspects, the other unpressurized cargo pallet 110B may return to the terrestrial origin empty (e.g. the other unpressurized cargo pallet 110B is installed on the space vehicle 101 without cargo 141A). In other aspects, the other unpressurized cargo pallet 110B, mounted to the space vehicle 101 or without the space vehicle 101, may be expendable and allowed to perish on return to the terrestrial origin such as by burning up on reentry to the terrestrial atmosphere.

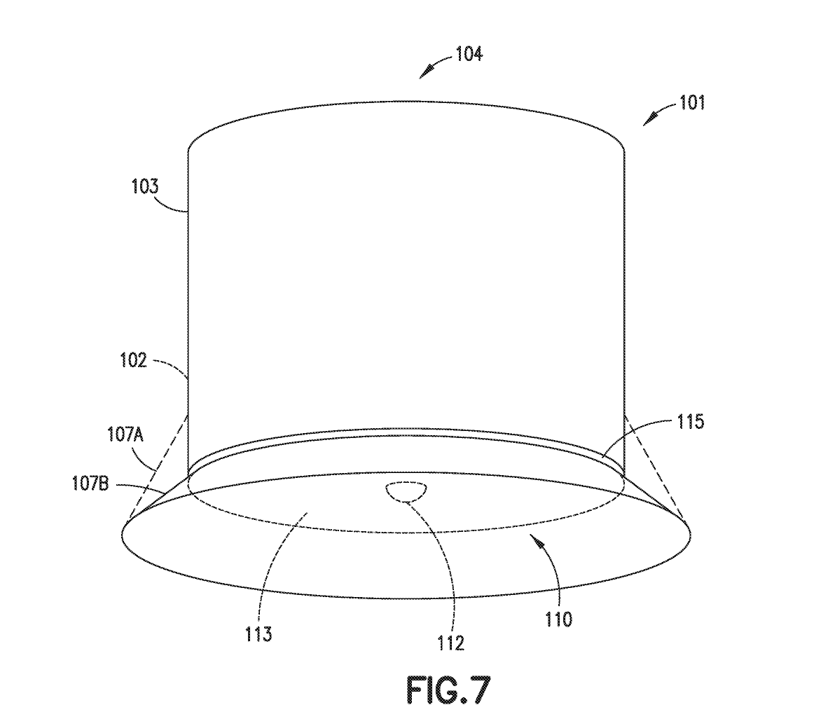

Referring now to FIGS. 1 and 7, in one aspect, the space vehicle 101 may include one or more fairing 107. In one aspect, the one or more fairing 107A may be attached to the frame 102 of the space vehicle 101 or, in other aspects, one or more fairing 107B may be attached directly to the at least one unpressurized cargo pallet 110. The one or more fairing 107 may be a soft fairing or a hard fairing and designed to protect the at least one unpressurized cargo pallet 110 and the at least one grapple 112 during travel into space. In one aspect, each unpressurized cargo pallet 110 mounted to the space vehicle 101 has a respective fairing 107 while in other aspects the fairing 107 is common to each of the unpressurized cargo pallet 110. In one aspect, the one or more fairings 107 are removed from the space vehicle 101 prior to removal of the at least one unpressurized cargo pallet 110.

Referring now to FIGS. 1, 5-7 and 8, an exemplary flow chart for the transfer of cargo 141 is shown in accordance with aspects of the disclosed embodiments. Before takeoff, for example from the terrestrial origin, the cargo 141 is loaded onto the at least one unpressurized cargo pallet 110 which in turn s coupled to the space vehicle 101 so that the cargo 141 is located within the interior cavity 104 of the space vehicle 101 for transport to an orbiting platform. In one aspect, during ascent, the at least one unpressurized cargo pallet 110 may carry between about 0% and about 100% of the total loads of the cargo 141. In one aspect, the at least one unpressurized cargo pallet 110 may carry between about 0% and about 100% of the total regional loads imparted on the space vehicle 101 during flight. In one aspect, the cargo 141 may be at least in part., carried through additional structure within the space vehicle 101 where the cargo 141 is later detached from the additional structure to allow operation of the at least one unpressurized cargo pallet 110 carrying the cargo 141, as described herein. In one aspect, the pallet base 115 and the at least one grapple 112 may be protected under one or more fairing 107.

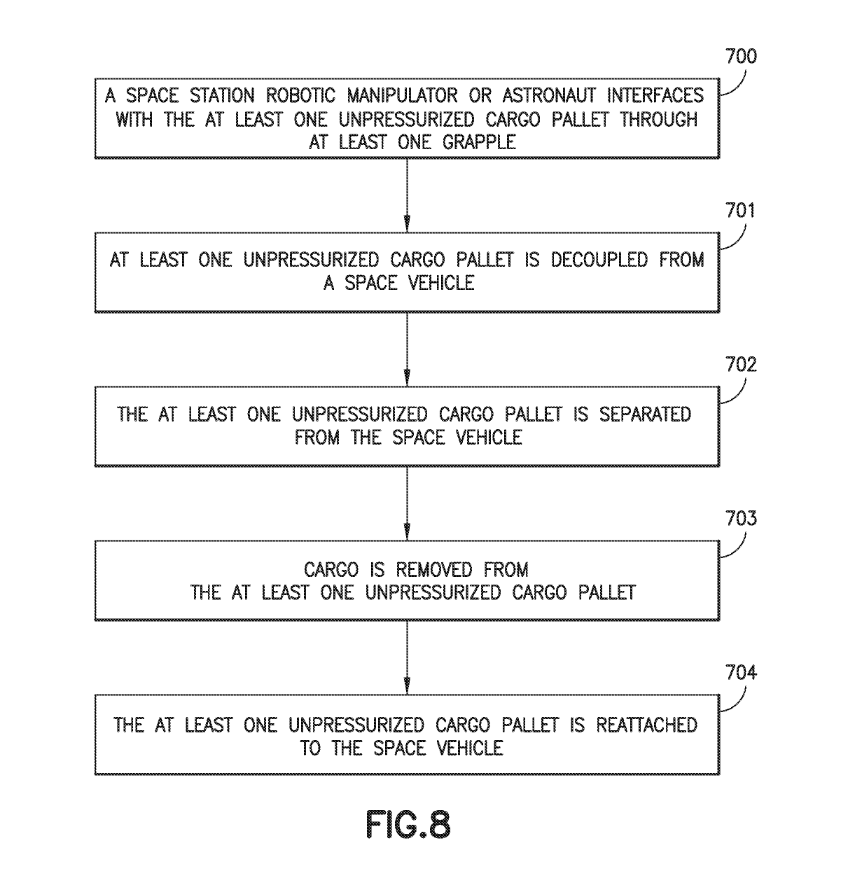

In one aspect, once in space the cargo 141 should not be removed from the vehicle until rendezvous with the orbiting platform is achieved. If included, as noted herein, the fairing 107 should be removed prior to rendezvous to expose the at least one grapple 112. Upon rendezvous with the orbiting platform, a robotic manipulator or astronaut interfaces with the at least one grapple 112, in the form of a robotic manipulator interface 130 and/or astronaut interface 131, of the at least one unpressurized cargo pallet 110. (FIG. 8, Block 700). The at least one unpressurized cargo pallet 110 is decoupled, with the cargo 141 affixed to the at least one unpressurized cargo pallet 110, from the space vehicle 101 (FIG. 8, Block 701) by disengaging the attachment mechanism, The at least one unpressurized cargo pallet 110 is then separated from the space vehicle 101 (FIG. 8, Block 702) by the robotic manipulator or astronaut, where the cargo 141, which is attached with the cargo attachment interface 114, and the unpressurized cargo pallet 110 are removed from the space vehicle 101 as a unit to expose the cargo 141 outside the outer mold line of the space vehicle 101. The cargo 141 is then removed from the at least one unpressurized cargo pallet 110 (FIG. 8, Block 703). The at least one unpressurized cargo pallet 110 may be temporarily or permanently attached to the orbiting platform for storage or reattached to space vehicle 101 (FIG. 8, Block 704) or may be disposed of.

In one aspect, cargo 141A may be reloaded onto the at least one unpressurized cargo pallet 110 prior to reinstallation on the vehicle. It may be for the purpose of temporary storage, or discard as the vehicle is undocked for descent. During reinstallation of the at least one unpressurized cargo pallet 110, full reattachment may not be required depending on vehicle variations such as if the space vehicle 101 is a reusable vehicle or a one-time use vehicle.

On descent, the other unpressurized cargo pallet 110B and other cargo 141A may be allowed to perish, or return to earth intact, depending on the mission requirements and vehicle configuration. In one aspect, the at least one unpressurized cargo pallet 110 and/or the space vehicle 101 may be recovered and refurbished for use on future flights.

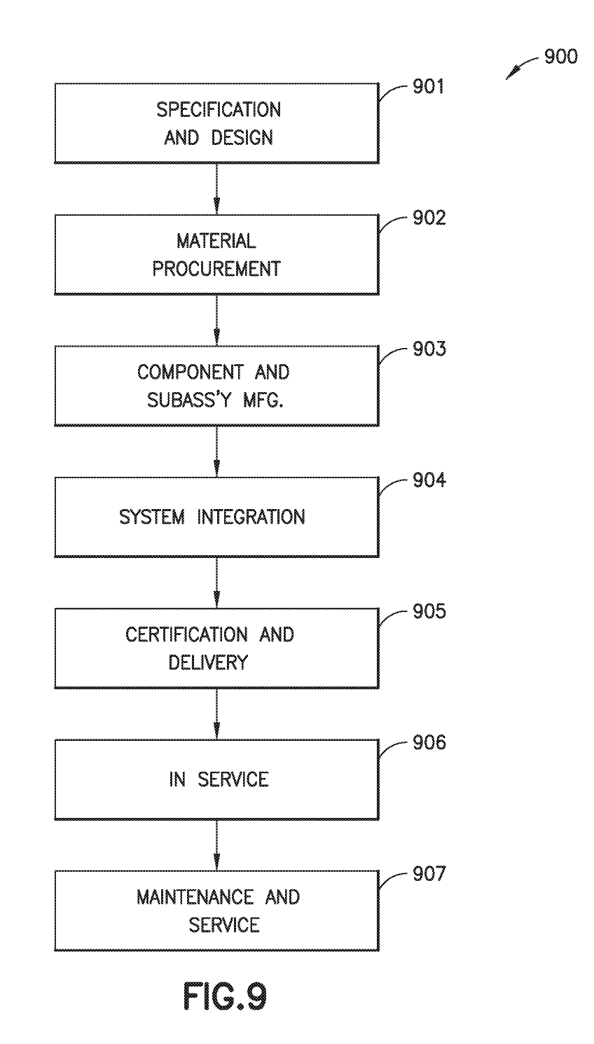

Examples of the disclosure may be described in the context of a spacecraft manufacturing and service method 900 as shown in FIG. 9 and a space vehicle 101 as shown in FIG. 10. During pre-production, illustrative method 900 may include specification and design 901 of the space vehicle 101 and material procurement 902. During production, component and subassembly manufacturing 903 and system integration 904 of the space vehicle 101 take place. Thereafter, the space vehicle 101 may go through certification and delivery 905 to be placed in service 906. While in service by a customer, the space vehicle 101 may be scheduled for routine maintenance and service 907 (which may also include modification, reconfiguration, refurbishment, and so on).

Each of the processes of the illustrative method 900 may be performed or carried out by a system integrator, a third party, and/or an operator (e.g., a customer). For the purposes of this description, a system integrator may include, without limitation, any number of spacecraft manufacturers and major-system subcontractors; a third party' may include, without limitation, any number of vendors, subcontractors, and suppliers; and an operator may be a space agency, leasing company, military entity, government entity, service organization, and so on.

As shown in FIG. 10, the space vehicle 101 produced by the illustrative method 900 may include an airframe 102 with a plurality of high-level systems and an interior cavity 104, Examples of high-level systems, which are distributed throughout the space vehicle 101, include one or more of a propulsion system 1003, an electrical power system 1004, a hydraulic system 1005, and an environmental system 1002. Any number of other systems may be included.

The system and methods shown or described herein may be employed during any one or more of the stages of the manufacturing and service method 900. For example, components or subassemblies corresponding to component and subassembly manufacturing 903 may be fabricated or manufactured in a manner similar to components or subassemblies produced while the space vehicle 101 is in service. Also, one or more aspects of the system, method, or combination thereof may be utilized during the production states 903 and 904, for example, by substantially expediting assembly of or reducing the cost of a space vehicle 101. Similarly, one or more aspects of the system or method realizations, or a combination thereof, may be utilized, for example and without limitation, while the space vehicle 101 is in service, e.g., operation, maintenance and service 907.

Different examples and aspects of the system and methods are disclosed herein that include a variety of components, features, and functionality. It should be understood that the various examples and aspects of the system and methods disclosed herein may include any of the components, features, and functionality of any of the other examples and aspects of the system and methods disclosed herein in any combination, and all of such possibilities are intended to be within the spirit and scope of the present disclosure.

Many modifications and other examples of the disclosure set forth herein will come to mind to one skilled in the art to which the disclosure pertains having the benefit of the teachings presented in the foregoing descriptions and the associated drawings.

In accordance with one or more aspects of the present disclosure, an unpressurized cargo pallet comprises a pallet base having a frame, the frame being conformal with a structural exterior surface of a space vehicle to effect structural integration of the pallet base with the structural exterior surface of the space vehicle so that the pallet base forms a portion of the structural exterior surface, where the frame includes an interior surface, and an exterior surface that forms at least park of the structural exterior surface of the space vehicle, a cargo attachment interface disposed on the interior surface of the frame, and at least one grapple disposed on the exterior surface of the frame.

In accordance with one or more aspects of the present disclosure the cargo attachment interface is a flight reusable attachment mechanism.

In accordance with one or more aspects of the present disclosure the at least one grapple includes a robotic manipulator interface.

In accordance with one or more aspects of the present disclosure the robotic manipulator interface comprises a space station robotic manipulator grapple.

In accordance with one or more aspects of the present disclosure the at least one grapple includes an astronaut interface.

In accordance with one or more aspects of the present disclosure the astronaut interface comprises one or more of an astronaut handhold or foothold.

In accordance with one or more aspects of the present disclosure the at least one grapple is removable from the exterior surface of the frame.

In accordance with one or more aspects of the present disclosure the at least one grapple is reconfigurable in orbit.

In accordance with one or more aspects of the present disclosure the unpressurized cargo pallet further comprises a mechanical fasteners to effect one of coupling and decoupling the pallet base to the space vehicle.

In accordance with one or more aspects of the present disclosure the unpressurized cargo pallet further comprises micro meteoroid and orbital debris protection members disposed on or integrated with at least one of the exterior surface or interior surface of the frame.

In accordance with one or more aspects of the present disclosure the unpressurized cargo pallet further comprises solar radiation protection members disposed on or integrated with at least one of the exterior surface or interior surface of the frame.

In accordance with one or more aspects of the present disclosure the unpressurized cargo pallet further comprises thermal protection members disposed on or integrated with at least one of the exterior surface or interior surface of the frame.

In accordance with one or more aspects of the present disclosure the unpressurized cargo pallet further comprises at least one communication antenna mounted to the pallet base.

In accordance with one or more aspects of the present disclosure the unpressurized cargo pallet further comprises a power system mounted to the pallet base to provide power to cargo carried by the pallet base.

In accordance with one or more aspects of the present disclosure the unpressurized cargo pallet further comprises a telemetry system mounted to the pallet base to provide at least a status of cargo carried by the pallet base or a status of the pallet base itself.

In accordance with one or more aspects of the present disclosure, a space vehicle comprises a frame having a structural exterior surface and forming an interior cavity, and at least one unpressurized cargo pallet, each unpressurized cargo pallet including a pallet base being conformal with the structural exterior surface of the frame of the space vehicle to effect structural integration of the pallet base with the structural exterior surface of the frame of the space vehicle so that the pallet base forms a portion of the structural exterior surface, where the pallet base includes an interior surface, and an exterior surface that forms at least part of the structural exterior surface of the frame of the space vehicle, a cargo attachment interface disposed on the interior surface of the pallet base, and at least one grapple disposed on the exterior surface of the pallet base.

In accordance with one or more aspects of the present disclosure the space vehicle is a. reusable space vehicle configured for reentry into Earth's atmosphere or an expendable vehicle intended to perish upon re-entry.

In accordance with one or more aspects of the present disclosure the space vehicle is manned or unmanned.

In accordance with one or more aspects of the present disclosure the space vehicle is a stand-alone orbiting or non-orbiting platform.

In accordance with one or more aspects of the present disclosure the cargo attachment interface is a flight reusable attachment mechanism configured to hold cargo within the interior cavity of the frame.

In accordance with one or more aspects of the present disclosure, the space vehicle further comprises fairings coupled to one of the structural exterior surface of the frame of the space vehicle or the exterior surface of the pallet base.

In accordance with one or more aspects of the present disclosure the at least one unpressurized cargo pallet is located on a side of the space vehicle.

In accordance with one or more aspects of the present disclosure the at least one unpressurized cargo pallet is located on a bottom of the space vehicle.

In accordance with one or more aspects of the present disclosure the at least one grapple includes a robotic manipulator interface.

In accordance with one or more aspects of the present disclosure the robotic manipulator interface comprises a space station robotic manipulator grapple.

In accordance with one or more aspects of the present disclosure the at least one grapple includes an astronaut interface.

In accordance with one or more aspects of the present disclosure the astronaut interface comprises one or more of an astronaut handhold or foothold.

In accordance with one or more aspects of the present disclosure the at least one grapple is removable from the exterior surface of the pallet base.

In accordance with one or snore aspects of the present disclosure the at least one grapple is reconfigurable in orbit.

In accordance with one or more aspects of the present disclosure, the space vehicle further comprises mechanical fasteners to effect one of coupling and decoupling the pallet base to the frame of the space vehicle.

In accordance with one or more aspects of the present disclosure, the space vehicle further comprises micro meteoroid and orbital debris protection members disposed on or integrated with at least one of the exterior surface or interior surface of the pallet base.

In accordance with one or more aspects of the present disclosure, the space vehicle further comprises solar radiation protection members disposed on or integrated with at least one of the exterior surface or interior surface of the pallet base.

In accordance with one or more aspects of the present disclosure, the space vehicle further comprises thermal protection members disposed on or integrated with at least one of the exterior surface or interior surface of the pallet base.

In accordance with one or more aspects of the present disclosure, the space vehicle further comprises at least one communication antenna mounted to the at least one unpressurized cargo pallet.

In accordance with one or more aspects of the present disclosure, the space vehicle further comprises a power system mounted to the at least one unpressurized cargo pallet to provide power to cargo carried by the at least one unpressurized cargo pallet.

In accordance with one or more aspects of the present disclosure, the space vehicle further comprises a telemetry system mounted to the at least one unpressurized cargo pallet to provide at least a status of cargo carried by the at least one unpressurized cargo pallet or a status of the pallet base itself.

In accordance with one or more aspects of the present disclosure a method of transferring unpressurized cargo comprises interfacing with a grapple disposed on an exterior surface of an unpressurized cargo pallet, exterior to a space vehicle to effect movement of the unpressurized cargo pallet relative to a frame of the space vehicle, where the unpressurized cargo pallet forms a portion of a structural exterior surface of the space vehicle and cargo carried by the unpressurized cargo pallet is disposed within an interior cavity of the space vehicle, decoupling the unpressurized cargo pallet from the frame of the space vehicle, and separating, through the interface with the grapple, the structural exterior surface of the space vehicle formed by the unpressurized cargo pallet from the frame of the space vehicle to remove the cargo carried by the unpressurized cargo pallet from the interior cavity.

in accordance with one or more aspects of the present disclosure the cargo and the structural exterior surface of the space vehicle formed by the unpressurized cargo pallet are removed from the space vehicle as a unit.

In accordance with one or more aspects of the present disclosure, the method further comprises reconfiguring the grapple in orbit.

In accordance with one or more aspects of the present disclosure, the method further comprises removing the cargo from the unpressurized cargo pallet and coupling the unpressurized cargo pallet back to the frame of the space vehicle.

In accordance with one or more aspects of the present disclosure, the method further comprises loading different cargo on the unpressurized cargo pallet prior to coupling the unpressurized cargo pallet back to the frame of the space vehicle.

In accordance with one or more aspects of the present disclosure, the method further comprises providing power to the cargo from a power system mounted to the unpressurized cargo pallet.

In accordance with one or more aspects of the present disclosure, the method further comprises providing at least a status of the cargo or a status of the unpressurized cargo pallet itself from a telemetry system mounted to the unpressurized cargo pallet.

In accordance with one or more aspects of the present disclosure a robotic manipulator interfaces with the grapple to separate the structural exterior surface of the space vehicle formed by the unpressurized cargo pallet from the frame of the space vehicle.

In accordance with one or more aspects of the present disclosure an astronaut interfaces with the grapple to separate the structural exterior surface of the space vehicle formed by the unpressurized cargo pallet from the frame of the space vehicle.

In accordance with one or more aspects of the present disclosure, the method further comprises decoupling the structural exterior surface of the space vehicle formed by the unpressurized cargo pallet from the frame of the space vehicle with self-decoupling mechanical fasteners.

Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain illustrative combinations of elements and/or functions, it should be appreciated that different combinations of elements and/or functions may be provided by alternative implementations without departing from the scope of the appended claims.

What is claimed is:

1. An unpressurized cargo pallet comprising:
a pallet base having a frame, the frame being conformal with a structural exterior surface of a space vehicle to effect structural integration of the pallet base with the structural exterior surface of the space vehicle so that the pallet base forms a portion of the structural exterior surface, where the frame includes
an interior surface, and
an exterior surface that forms at least part of the structural exterior surface of the space vehicle;
a cargo attachment interface disposed on the interior surface of the frame; and
at least one grapple disposed on the exterior surface of the frame.

2. The unpressurized cargo pallet of claim 1, wherein the cargo attachment interface is a flight reusable attachment mechanism.

3. The unpressurized cargo pallet of claim 1, wherein the at least one grapple includes one or more of a robotic manipulator interface and an astronaut interface.

4. The unpressurized cargo pallet of claim 1, wherein the at least one grapple is removable from the exterior surface of the frame.

5. The unpressurized cargo pallet of claim 1, wherein the at least one grapple is reconfigurable in orbit.

6. The unpressurized cargo pallet of claim 1, further comprising mechanical fasteners to effect one of coupling and decoupling the pallet base to the space vehicle.

7. The unpressurized cargo pallet of claim 1, further comprising one or more of:
micro meteoroid and orbital debris protection members disposed on or integrated with at least one of the exterior surface or the interior surface of the frame;
solar radiation protection members disposed on or integrated with at least one of the exterior surface or the interior surface of the frame; and
thermal protection members disposed on or integrated with at least one of the exterior surface or the interior surface of the frame.

8. The unpressurized cargo pallet of claim 1, further comprising at least one communication antenna mounted to the pallet base.

9. The unpressurized cargo pallet of claim 1, further comprising a power system mounted to the pallet base to provide power to cargo carried by the pallet base.

10. The unpressurized cargo pallet of claim 1, further comprising a telemetry system mounted to the pallet base to provide at least one of a status of cargo carried by the pallet base or a status of the pallet base.

11. A space vehicle comprising:
a frame having a structural exterior surface and forming an interior cavity; and
at least one unpressurized cargo pallet, each unpressurized cargo pallet including
a pallet base being conformal with the structural exterior surface of the frame of the space vehicle to effect structural integration of the pallet base with the structural exterior surface of the frame of the space vehicle so that the pallet base forms a portion of the structural exterior surface, where the pallet base includes
an interior surface, and
an exterior surface that forms at least part of the structural exterior surface of the frame of the space vehicle,
a cargo attachment interface disposed on the interior surface of the pallet base, and
at least one grapple disposed on the exterior surface of the pallet base.

12. The space vehicle of claim 11, wherein the space vehicle is an expendable vehicle or a reusable space vehicle configured for reentry into Earth's atmosphere.

13. The space vehicle of claim 11, wherein the space vehicle is manned or unmanned.

14. The space vehicle of claim 11, wherein the space vehicle is a stand-alone orbiting or non-orbiting platform.

15. The space vehicle of claim 11, wherein the cargo attachment interface is a flight reusable attachment mechanism configured to hold cargo within the interior cavity of the frame.

16. The space vehicle of claim 11, wherein the at least one unpressurized cargo pallet is located on one or more of a side of the space vehicle and a bottom of the space vehicle.

17. The space vehicle of claim 11, wherein the at least one grapple is removable from the exterior surface of the pallet base.

18. The space vehicle of claim 11, further comprising one or more of:
micro meteoroid and orbital debris protection members disposed on or integrated with at least one of the exterior surface or the interior surface of the pallet base;
solar radiation protection members disposed on or integrated with at least one of the exterior surface or the interior surface of the pallet base; and
thermal protection members disposed on or integrated with at least one of the exterior surface or the interior surface of the pallet base.

19. A method of transferring unpressurized cargo, the method comprising:
interfacing with a grapple disposed on an exterior surface of an unpressurized cargo pallet, exterior to a space vehicle to effect movement of the unpressurized cargo pallet relative to a frame of the space vehicle, where the unpressurized cargo pallet forms a portion of a structural exterior surface of the space vehicle and cargo carried by the unpressurized cargo pallet is disposed within an interior cavity of the space vehicle;
decoupling the unpressurized cargo pallet from the frame of the space vehicle; and
separating, through the interface with the grapple, the structural exterior surface of the space vehicle formed by the unpressurized cargo pallet from the frame of the space vehicle to remove the cargo carried by the unpressurized cargo pallet from the interior cavity.

20. The method of claim 19, wherein the cargo and the structural exterior surface of the space vehicle formed by the unpressurized cargo pallet are removed from the space vehicle as a unit.
